(19) United States
(12) Patent Application Publication
(10) Pub. No.: US 2023/0100255 A1
(43) Pub. Date: Mar. 30, 2023

(54) SYSTEM AND METHOD FOR INTERACTIVE CONTOURING OF MEDICAL IMAGES

(71) Applicant: Mirada Medical Limited, Oxford (GB)

(72) Inventors: Mark Gooding, Oxford (GB); Djamal Boukerroui, Oxford (GB); Michael Johann Trimpl, Oxford (GB)

(21) Appl. No.: 17/909,421

(22) PCT Filed: Mar. 4, 2021
(86) PCT No.: PCT/EP2021/055462

§ 371 Date: Sep. 5, 2022

(30) Foreign Application Priority Data
Mar. 5, 2020 (GB) 2003239.7
May 21, 2020 (GB) 2007590.9

(51) Int. Cl. G06T 7/10

(52) U.S. Cl. CPC G06T 7/10; G06T 7/174

(57) ABSTRACT

A method and imaging system for contouring medical images is described. The method comprising: receiving at least one input 2D image slice, from a set of two-dimensional (2D) image slices constituting the 3D image, and at least one set of data representing an input contour identifying one or more structures of interest in the 3D image within the at least one input 2D image slice; receiving at least one selected target image slice, from the set of the 2D image slices; and predicting target contour data for the selected target image slice that identifies at least one of the same one or more structures of interest within the target image slice, based on one or more of the received input 2D image slices and the data representing an input contours.

### FIELD OF INVENTION

This invention relates to the fields of medical imaging and radiotherapy planning. In particular, the contouring of different anatomical structures for radiotherapy treatment planning by, for example, a radiation oncologist. The invention provides tools for an interactive application for contouring medical images.

### BACKGROUND OF INVENTION

### Image Segmentation

Many medical applications rely on accurate segmentation of anatomical structures shown in medical images. Segmentation of images, obtained from e.g. CT or MRI, may be needed in computer-based surgery planning, minimal invasive surgery or for diagnosis and for treatment delivery and monitoring purposes.

Image segmentation is extensively used in radiotherapy planning to identify healthy and cancerous body regions (Ramkumar, 2016). The size and the location of a tumour are important indicators contributing to the decision process on the choice of the best treatment delivered to the patient. An accurate segmentation of both healthy organs and cancerous regions on an image, is required in order to maximize the delivered dose of radiation to the tumour while minimizing the dose on healthy tissues. The segmentation of healthy organs and cancerous regions on an image is known in the clinic as “contouring”, as a contour is drawn around each structure on the image, generally image slice by image slice. As used herein, a contour is defined as the outline of a structure of interest, such as an organ or a tumour. A contour set is a set of contours that are associated with the image slices within a 3D medical image, and contour data is data that contains information about the contours associated with an image. A Ground Truth (GT) is a contour provided by a clinical expert, used for reference, as well as for model training, testing and evaluation.

Manual image contouring is a time-consuming process and subject to significant inter- and intra-observer variability. Consequently, semi-automatic and fully automatic image segmentation tools are needed not only to reduce delineation time but also to improve image segmentation consistency.

Atlas-based auto-segmentation (ABAS) is the most common commercial image contouring system. In ABAS, 3D images of previously contoured cases (referred to as atlases) are aligned to the 3D image of the current patient using deformable image registration (Sharp, 2014). The alignment found in registration is then applied to contours of the atlas and thus transferred to the patient image. It is not always possible to achieve good alignment between the atlas image and the patient image and as a result ABAS faces challenges in image segmentation.

Recently, machine learning (ML)-based approaches have been employed with great success to automatically contour medical images (Lustberg, 2018). ML-based approaches learn from training sets (image+contours) of previously contoured patients in order to infer the shape and location of contours in new unseen images. When the training is performed using a sufficiently large and representative data set, ML-based approaches have been shown to generate contours indistinguishable from manually drawn contours (Gooding, 2018).

Fully automatic image segmentation techniques do not require any type of user inputs or interaction, enabling more time-efficient and reproducible segmentation routes. Automatic image segmentation techniques however fail when the postulated assumptions inherent to the ML model or to the image-based similarity measure used in ABAS are violated. For example, the high variability in the size, location and appearance of tumours in the images makes it challenging to build a representative training set resulting in a decreased performance of ML methods. Therefore, human input is currently required for segmentation of structures whose appearance and location exhibit large variability. In essence, automatic tools are unable to segment structures that they have not been designed for.

### The Need for Interactive Segmentation

Fully automated contouring methods are imperfect and clinical experts need to review and often edit the generated contours and so to prevent errors in the medical treatment planning. User-interaction is an essential component of a medical image segmentation workflow and an integration of interactivity to assist fully automated processes is necessary.

To overcome the drawbacks of fully automatic image segmentation techniques, semi-automatic methods are employed. Such approaches improve segmentation accuracy compared to fully automatic techniques by integrating user inputs as constrains to guide the segmentation process. Compared to fully manual segmentation, interactive techniques are known to improve repeatability and consistency across multiple observers (e.g. Olabarriaga, 2001; Wang, 2018; Sakinis, 2019)

The Difficulty with Interaction:

Anatomical structures are three dimensional (3D). The medical imaging techniques used in a radiotherapy department (for example CT, MRI) are also 3D imaging techniques and thus generates 3D data sets. However, most of clinically available visualization tools and devices are 2D in nature. Thus, most of interactive segmentation techniques are restricted in their interaction by the 2D nature of the visualization device. Very few 3D-specific interactive methods exist in the literature (Ramkumar, 2016). Furthermore, most of these techniques are extensions of 2D interactive segmentation methods. For example, the trivial extension of the popular 2D Graph-cut based segmentation (Boykov, 2000) to 3D results into a high degree of 2D interactions (see e.g. Ardon, 2006). The extension of minimal path techniques from 2D (LiveWire image processing and variants) to 3D is a much harder problem (see e.g. Ardon, 2006). In contrast to Graph-cut techniques where user inputs are strokes drawn on 2D image slices, in minimal path techniques, the user is asked to draw the correct contour on a few image slices, and then the algorithm solves for the missing contour on the rest of the 3D structure.

Ramkumar el al. (2016) showed that “contour” based interaction is more intuitive but less efficient in comparison to stroke techniques. The luck of efficiency is mainly due to the higher degree of interaction needed for the “contour” based interaction. The luck of efficiency of “contour” based method can be addressed by a better segmentation algorithm for the automatic part of the method that integrates more and better the “contextual information” provide by the user or available in the image data. For example, a tumour node may be indistinguishable from tubular structures such as arteries, when looking at a single image slice. Image slices above and below the tumour (spatial context) can help distinguish between the two. Spatial context can be provided and used in different ways:

(More) User interaction to lift such ambiguities. This can be implemented in different forms, for example, by scribbles (Lin, 2016) mouse clicks on image foreground or image background (Sakinis, 2019) or edits to auto-generated contours (Wang, 2017).

By using the previous interactions and segmentation results on adjacent image slices efficiently.
By using the previous interactions and segmentation results over a population of data. This requires the use of machine learning techniques.

Consequently, interactive methods for 3D images can be addressed through intuitive user interaction in 2D, while using the additional spatial context available through the remaining image slices in the 3D image and by using an efficient automatic contour prediction engine that integrated spatial context information over a population of examples. Specifically, a user may interact with a single image slice by contouring a structure in that image slice. Starting from this interaction, a ML model may learn to segment structures on nearby image slices. The ML model can infer the contours based on the spatial information such as similar location on an image slice, similar intensity values, or morphology. Two-dimensional interaction keeps the interaction mechanism simple and intuitive, while the benefits of 3D segmentation are retained through the provision of spatial context to the ML model. The inference of corresponding structures from one image slice to another image slice is also referred to as spatial propagation.

We use the wording “Contextual information” to refer to salient information taken from the target image slice, the input image slice(s) and the associated input contour(s) used by the contour prediction engine to identify the relevant location of contour on the target image slice. In the learning process, the contour prediction engine is optimized to learn and extract salient image features and spatial relations between the image data, the available 2D contours of the 3D structure to contour on neighbouring input image slices, whether predicted, user corrected or manually drawn or any additional user interaction in the contouring process. It will also learn the relative importance or significance of each. Thus, contextual information may refer to the features shared between the target image slice and the input image slice(s) that allows for an accurate propagation of the contours from one image slice to another, for example, similar contrast along contour between two adjacent image slices.

### Application Examples of Segmentation:

A user wants to contour the lung in 3D CT image and is presented with an unannotated CT image. If no automated contouring tool is available all image slices need to be contoured manually. Using a fully automated approach, first the contours of the lung on all image slices are generated using a fully automatic segmentation tool, then the user needs to perform a slice-by-slice validation for all image slices and makes manual edits to correct for errors on each image slice as required.

In a semi-automatic approach, the user may pick an arbitrary first image slice within the CT image where a lung is visible on the image slice and contour the lung on this first image slice; then the manually drawn contour can be automatically propagated through the CT stack of image slices using a contour prediction engine. Further edits can be made to the resulting contours and be updated throughout the CT based on further user inputs. The lung contour on the first image slice can also be a manually edited contour generated using a fully automatic contouring tool.

### PRIOR ART

Here we will introduce prior art relating to interactive image segmentation focusing on those related to medical imaging, as well the use of ML in a segmentation algorithm. First, methods that used ML in a fully automated segmentation and their shortcomings compared to interactive methods are discussed. Then methods in 2D image segmentation are briefly addressed, followed by current approaches in 3D medical imaging.

### Fully Automated Segmentation Using ML

Many different ML approaches to fully automatic segmentation have been discussed in the literature. Here, we give two examples of how ML can be used for automatic segmentation.

The work by China et al. (2019) describes a two steps fully automatic segmentation method that makes use of a ML method. In the approach by China et al., ML, specifically a random forest, is used to learn a statistical model of the image data; The model is then used by an Iterative Random Walker to obtain a weak estimate of a structure on a 2D slice. This estimate is used in the second step, to initialise a fully segmentation algorithm. In the approach by China et al. ML is only used for some parts of the segmentation process and is thus not used to its fullest potential.

WO2017/091833 describes an automatic contouring method that fully applies ML to the segmentation task. The method described in WO2017/091833 is similar to the U-Net architecture (Ronneberger et al., 2015). WO2017/091833 describes the training of a Convolutional Neural Network (CNN) for fully automatic segmentation of anatomical structures. The training data may consist for example of a set of image data and a set of contour data that identifies the structures to be segmented. A model trained as described in WO2017/091833 will be able to segment the structures that were presented in the training set for new image sets.

However, a model trained using the method described in WO2017/091833 can only be used on data that is very similar to the training data. Furthermore, such a model cannot segment structures that were not represented in the training data because WO2017/091833 performs segmentation utilizing the received image data alone. User interaction needs to be incorporated in ML approaches to overcome these limitations. The training of an interactive ML model is fundamentally different to WO2017/091833. An overview of different interactive segmentation approaches is given below.

### Interactive 2D Image Segmentation Approaches

There are many methods in the literature that address the integration of interactivity in 2D segmentation tasks (e.g. U.S. Pat. Nos. 7,277,582; 8,218,870; 9,495,755, Criminisi, 2008; Bai, 2009). All these 2D approaches require a high level of interaction. The level of interaction should increase further if such methods are used on 3D data sets or for large organs/tumours. Few of them also rely on accurate foreground and background models, and therefore require a high degree of interaction.

### Interactive 3D Segmentation in Medical Images

The authors in U.S. Pat. No. 9,317,927 highlighted the lack of intuitiveness of existing interactive 3D image segmentation techniques. They proposed the use of an image segmentation uncertainty indicator to guide subsequent user inputs. This may reduce the number of required user interaction however it may also lead to a decrease of the intuitiveness of the interaction.

EP1999717 and US20140301624A1 describe interactive thresholding techniques of multidimensional images (2D or 3D). The user interaction in both inventions is a mouse click and drag operation. The computational part in EP1999717 is a simple image intensity thresholding, controlled by the dragging operation. In U.S. Ser. No. 14/360,208 a subsequent connected component analysis is used to exclude regions that do not include the clicked point. Both these citations are recent inventions, probably very effective and useful because the interaction is highly intuitive. Their computational parts are however very simple and almost trivial which limits the potential of the approaches. Indeed, both methods only consider basic image intensity thresholding and therefore their effectiveness will be highly limited by the quality of the images. For example, we would expect them to perform poorly on noisy images such cone-beam CT images or on images with a bias field that may be present in MRI. Thus, these approaches are unlikely to perform well in an application such as contouring in a radiotherapy workflow.

### Interactive Contour Propagation Methods

U.S. Pat. No. 9,792,525 describes an interactive 3D segmentation in analogy to ABAS, by having the user contour one image slice within the 3D image and performing a slice-to-slice registration between that image slice and the image slice to be segmented. Therefore, this method inherits from known limitations of ABAS, namely the difficulty to solve the underlying registration problem accurately especially when segmenting image slices further away from the image slice associated with the input contour. Additionally, this method cannot handle topological changes of the propagated contour which may lead to problems in heterogenous structures such as tumours. Such topological changes may be important in the segmentation performance, particularly with non-homogenous structures, such as tumours. The imperfect alignment after registration may become particularly apparent when segmenting image slices further away from the image slice associated with the input segmentation. In contrast, the disclosed ML based approach can better handle such cases and result in an improved contouring performance.

Automated image segmentation using ML has shown great success in the past and recently semi-automatic ML based segmentation methods have showed promising results. Machine learning solutions to medical image segmentation tasks in many applications are now the state-of-the-art method. Yet, many of these solutions lack the user interactivity that, as discussed above, is essential to ensure the quality of segmentation required in the medical workflows.

Machine learning models performing slice-by-slice image segmentation using only the image slice to be segmented of e.g. a CT are limited in their predictive power as these models do not consider spatial context information. However, spatial context has been shown to improve contouring results in recent works, where different approaches have been considered to improve segmentation results (Léger et al. 2018; Zheng et al. 2018; Novikov et al. 2018). For instance, Léger et al. (2018) proposed a ML model that takes user interaction at one image slice to estimate the segmentation mask at nearby image slices. Although the spatial context used in Léger et al. (2018) is very limited, it showed that it can improve segmentation. Specifically, the work of Léger et al. uses the U-Net architecture and provides additional context by choosing an additional input to the ML model through the segmentation result of a CT image slice at a certain number of image slices away from the CT image slice to be segmented. This work was limited to the segmentation of one predefined anatomical structure (i.e. the bladder).

Similarly, Zheng et al. (2018) used an alike architecture for multi-class image segmentation of the cardiac system including the left and right ventricular cavity and the left ventricular myocardium. In this work, the segmentation of the target image slice was achieved, by providing as input, the target image slice to be segmented in addition with an image slice and its associated segmentation. The image slice with its associated segmentation can be a certain number of slices away from the target slice to be segmented. This work showed that segmentation performance can be improved, by providing a previous image slice with its associated segmentation as input.

However, these works and further works that look at spatial context in ML models focus on the segmentation of a predefined structure or set of structures. Therefore, these networks are not trained and optimized to detect contextual features relating to user interaction or to adjacent image slices, but mostly the features relevant to the specific structure(s) that they are trained on. These models perform poorly when trying to segment other unseen structures—structures not included in the training set. Such models are narrowly specialized such that a given user interaction targeting an unseen structure is ignored by the segmentation engine.

To demonstrate this, we trained a ML model with a neural network architecture similar to Léger et al. using only the “heart” as a structure to be segmented. The model predicts the contour on a target image slice using the following inputs:

1) The target image slice (to be segmented)
2) An image slice and its associated contour

The image slice selected in step 2) was 8 slices away for the target image slice to be segmented. The ML model was trained exclusively using heart contours. At testing, the ML model was shown contours corresponding to different organs to be segmented. The organs included heart, esophagus, left lung, right lung and spinal cord. The segmentation performances for each organ are summarized in FIG. 1. FIG. 1(a) shows plots of the Dice score (1=perfect image segmentation, 0=worst image segmentation, the Dice score is the value of the Sorensen-Dice coefficient and is a relative measure of area or volume overlap between two contours) as a measure of segmentation performance versus the number of iterations of the model training, for each of the different organs.

Observe that when the model is asked to predict the segmentation of a heart while trained how to segment a heart, the segmentation performance increases with the training iterations. However, when the model is asked to predict the segmentation of a different organ (other than a heart) while the model was previously trained how to segment a heart, the image segmentation performance decreases with the training iterations, for the other organs. Consequently, after training for 40 iterations, a very good segmentation performance is obtained for segmenting hearts (FIG. 1b), but the model fails completely to segment other organs. As shown in FIG. 1, the Dice score for the segmentation of the heart was 0.91 for the single-organ model that was trained using a heart-only training set, and the mean Dice score for the other 4 OARs (Organs At Risk) was 0.025.

The significant drop of segmentation performances from iteration 1 to iteration 40 for all organs as shown in FIG. 1 (with the exception of the heart) indicates:

While the model is learning the heart, it also indiscriminately learns what organs are not a heart;

The model ignores any user inputs that is not a heart contour;

The second point highlights that such models are actually very limited in taking into account the user inputs. Their ability to learn a good representation of the provided spatial context is questionable.

One could imagine training separate image segmentation engines for different structures and have the user select which organ to contour or have an algorithm choose which model to apply. However, this would require creating a training set for all specific objects of interest for the distinct models. It is however unclear what these structures are and the variability of some structures such as tumours makes it difficult to even construct a representative training set. Thus, there is need for a more generalized approach that uses contextual information provided by the user to enable the segmentation of any object of interest in a 3D medical image scan.

There is a need for a fast and intuitive interaction method for image segmentation in 3D medical images which accounts for user provided contextual information to segment the object of interest in the image.

State-of-the-art tools to segment medical images often only work effectively within a narrow range of conditions and are not suitable for de-novo contouring. Moreover, current partially or fully automated approaches for image contouring lack user-interactivity. The above-mentioned solutions are rigid in their predictions or don't allow for efficient use of the user interactivity. A few methods for image contouring take into account spatial context; however, they are not able to generalize to various target structures and more importantly do not utilize efficiently the provided user interaction

Contour quality and speed in contouring are key to successful radiotherapy planning. This can be achieved if adaptive and interactive contouring tools are available. Automated deep learning contouring has been shown to be beneficial in contouring OARs, but such approaches require a large volume of training data. In the absence of such data, for example when contouring previously unconsidered structures, manual contouring is required. The manual contouring can be assisted by the disclosed interactive contouring method by considering spatial context, reducing inter-user variability and time spent on contouring.

The disclosed method of the subject invention addresses the problems discussed above and shows how an interactive contouring model can be constructed that can assist clinicians in contouring tasks of previously unconsidered structures on a medical image. Preferably, the model is a machine learning model.

In an embodiment of the invention there is provided a method of contouring a three-dimensional (3D) medical image, comprising: receiving at least one input 2D image slice, from a set of two-dimensional (2D) image slices constituting the 3D medical image, and at least one set of data representing an input contour identifying one or more structures of interest in the 3D medical image within the at least one input 2D image slice; receiving at least one selected target image slice, from the set of the 2D image slices; and predicting target contour data for the selected target image slice that identifies at least one of the same one or more structures of interest within the target image slice, based on one or more of the received input 2D image slices and the data representing an input contours.

Preferably, the target contour prediction is done using a machine learning model. Further preferably, the machine learning model is one or more of a neural network or random forest.

In an embodiment of the invention, the input contour identifying one of more structures of interest is identifying a previously unidentified structure of interest.

Further preferably, at least one of: the target image slice, the input image slice, and the input contour, provides contextual information to identify a relevant location for a contour on the target image slice. In a still further preferred embodiment of the invention the contextual information is provided from a plurality of sources comprised of at least one input image slices, at least one input contour, and a target image.

Preferably, the contextual information comprises one or more of information on image features and/or contour features, or spatial relations between image data and/or contour data. In an embodiment of the invention, the contextual information on spatial relations between image data and/or contour data is learnt from a training data set.

Preferably, the contextual information is information relating to one or more features shared between image slices in the set of 2D image slices.

In an embodiment of the invention, the image slices in the set of 2D image slices are consecutive image slices

In a preferred embodiment of the invention the image is a medical image and the modality of the 3D image is one of: CT, MRI, Ultrasound, CBCT.

Further preferably, the machine learning model for predicting target contour data has been trained using an image dataset that includes a plurality of images each with one or more structures of interest shown on the images.

Preferably, the structures of interest include human organs and or tumours in a human body.

In an embodiment of the invention, the training of the machine learning model is performed on multiple imaging modalities. In a preferred embodiment the method also comprising the step of updating the machine learning model based on user edits to the received structures

Preferably, contours for adjacent image slices from the set of two-dimensional (2D) image slices are sequentially predicted. In a still further preferred embodiment a predicted contour for the n^{th} image slice of the set of two-dimensional image slices becomes the input for the (n+1)^{th} slice.

In an embodiment of the invention one or more of the predicted 2D contours are used to create 3D contour. Further preferably, all of the predicted contours are used to create the 3D contour.

In a preferred embodiment of the invention, a first structure of interest is selected for a first image slice and contours for the first structure are predicted for a first image slice, and the predicted contours for the first image slice are used for contouring the same structure of interest for subsequent image slices from the set of image slices.

Further preferably, at least one further structure of interest is selected for a first image slice and target contours are also predicted for at least one of the further structures of interest for the image slice.

In an embodiment of the invention, the predicted contours are propagated through sequential image slices using direct propagation of the predicted contours. Preferably, a target contour is predicted, and then added to the contour set. Further preferably, the target contour is edited after it is predicted and before it is added to the contour set.

Further preferably, the predicted contours are propagated through sequential image slices by iterative propagation, with predicted contours each subsequent image propagated based on iteration of the contours for the immediately preceding image slice. Preferably, the contours are propagated through all intermediate image slices until the target image slice is contoured.

In a preferred embodiment of the invention, the target contour is edited after it is predicted and before it is added to the contour set.

In an embodiment of the invention, one or more predicted contours are edited before that are propagated through sequential images. Preferably, the contours are manually edited before propagation through sequential images.

Further preferably, the 2D input image slice and target image slice to be contoured are adjacent slices from the set of 2D image slices. In an embodiment of the invention the 2D input image slice is a plurality of input image slices.

Preferably, the 2D input image slice and the target image slice to be contoured are non-adjacent slices from the set of 2D image slices. In a preferred embodiment of the invention the data representing an input contour is a user-generated contour.

In a further preferred embodiment of the invention, the data representing an input contour is obtained by one or more of manual contouring, auto contouring, or user interactive contouring.

According to the invention there is also provided an imaging system for contouring a 3D system using the method described above.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1a: Performance of a single-structure model trained on the heart, during iterations of training;

FIG. 1b: Performance of a single-structure model trained on the heart at iteration 40;

FIG. 2a: Performance of a multi-structure model, during iterations of training;

FIG. 2b: Performance of a multi-structure model at iteration 40

FIG. 3: Simplified block diagram of an example of a system for the segmentation of a 3D image according to the invention;

FIG. 4: Different variants of data inputs for the contour prediction engine;

FIG. 5: Block diagram of an interactive contouring workflow of a 3D medical image according to the invention;

FIG. 6a: Illustrative example for target contours prediction for 3D medical image with iterative propagation showing Initial state, 3D image;

FIG. 6b: Illustrative example for target contours prediction for 3D medical image with iterative propagation showing contour prediction with iterative propagation;

FIG. 6c: Illustrative example for target contours prediction for 3D medical image with iterative propagation showing final state 3D image with contours;

FIG. 7a: Illustrative example for target contours prediction for 3D medical image with propagation, using user initial image slice only showing Initial state, 3D image;

FIG. 7b: Illustrative example for target contours prediction for 3D medical image with propagation, using user initial image slice only showing contour prediction with user initial image slice;

FIG. 7c: Illustrative example for target contours prediction for 3D medical image with propagation, using user initial image slice only showing Final state 3D image with contours;

FIG. 8: Block diagram for training a Machine Learning model for a contouring application;

FIG. 9: Generation of training sets for multi-structure training of a Machine Learning model;

FIG. 10a: Schematic example of an image with the associated contours identifying the different structures used for training the ML model;

FIG. 10b Schematic examples of images with structures/organs to be contoured showing an example of an unseen structure by the ML in training.

FIG. 11 Illustrative examples of image planes as used in 3D medical images.

FIG. 12 shows comparison of Ground Truth (GT) and predictions of a single organ heart model;

FIG. 13 shows comparison of ground truth (GT) and predictions of a multi-organ model trained on oesophagus, heart, lung, left and right lung and spinal cord.

### DETAILED DESCRIPTION

While deep learning contouring has been shown to be beneficial in automatic contouring OARs on image slices, such approaches require a large volume of training data. In the absence of such data, for example when contouring previously unconsidered organs, manual contouring of the image slices is required.

This invention uses an interactive contouring approach preferably within a deep-learning framework and investigates how this contouring approach behaves when provided with contextual information. It was found that despite using an architecture that has contextual information available to it, the model only learns to segment a known organ if training is only performed on single organ data. Using training data from multiple organs enforces that the context provided by the user is learnt.

In contrast to the prior art methods discussed above, the disclosed method for this invention requires a model that can contour various structures of interest (that may be an organ in the human body, or other structure in the human body such as a tumour) on an image slice from the contextual information provided as described above. The contouring of various different structures of interest on an image slice can be achieved, for example, by training the model on multiple different structures (such as heart, lung, spinal cord, etc. . . . ) simultaneously. Such models should be able to provide outputs that reflects better the user guidance when segmenting and contouring previously unseen structures in a medical image, as a variety of structures were used in the training of the model. Preferably the model is a machine learning model.

The disclosed invention addresses the problem of segmenting a previously unseen object or organ in a medical image using machine learning methods that takes account of user provided contextual information, such as a user-generated contour. Using input limage slices and input contours of a stucture of interest, the contour of the structure of interest on a target image slice is predicted using a contour prediction engine. In this invention, the input contour identifies the structure of interest on the input image slice.

This approach enables contouring of a structure of interest on a medical image, even if the structure of interest has not been represented in the training set of the model. So for example, if the training set was all of images on which only the organs were contoured, the model can still be applied to contour other structures in a new image such as tumours. This greatly increases the efficiency of the model.

The medical image contouring system described herein, provides the methods and tools for contouring a 3D medical image, composed of a stack of 2D image slices. In an example of the invention the stack may include all sequential images, or a range of one or more images selected from a sequence, such as every alternate medical image in the sequence for example. An example image contouring system in an embodiment of the invention may include a medical image database and a contour prediction engine. In an embodiment of the invention, the image database may be used to store a set of medical images, that are 2D and/or 3D medical images. In an embodiment of the invention the contour prediction engine may be configured to receive at least one input image slice from a set of two-dimensional image slices, with associated contour data representing an input contour identifying one or more structures of interest to the user and to also receive a target image slice from a 3D medical image in the image database. In an embodiment of the invention the structures of interest may have been previously unidentified. The contour prediction engine may further be configured to use a model, for example a machine learning model to predict the target contour data for the previously unidentified structure of interest on the target image slice, based on one of more of the received input 2D image slices and the associated data representing an input contour.

An example for contouring a 3D medical image may include the following steps: receiving an input 2D image slice from the 3D medical image and input contour data associated with the input 2D image slice, the input contour data identifying the one or more structures within the input 2D image slice; identifying a target image in the 3D medical image to contour; using a machine learning model to generate the target contour, the target contour data identifying the same one or more structures within the target image.

A model, such as a machine learning model that is used within the contour prediction engine, is required to be able to identify structures (such as heart, lungs, oesophagus, spinal cord for example) that have been used within the training set of the machine learning model. The model should also be able to handle unseen structures—structures that have not been previously included in the training set of the machine learning model-. In an embodiment of this invention this is achieved by simultaneously training the model using various different anatomical structures within the training set.

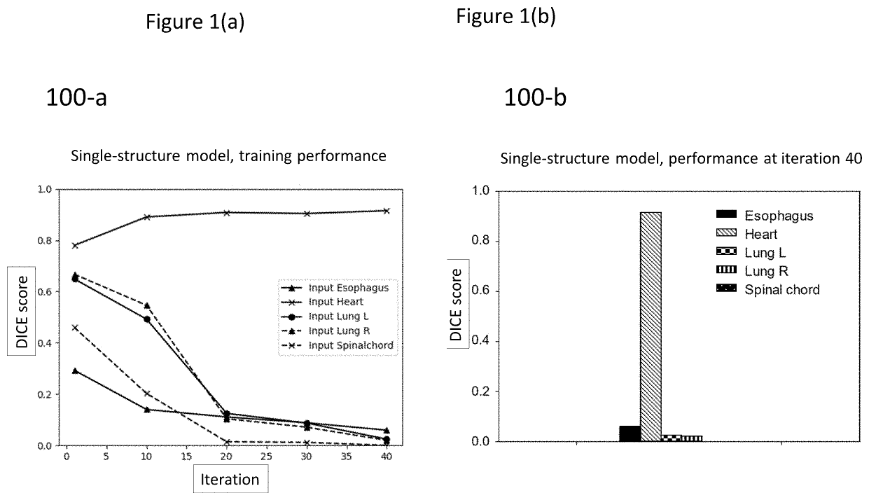

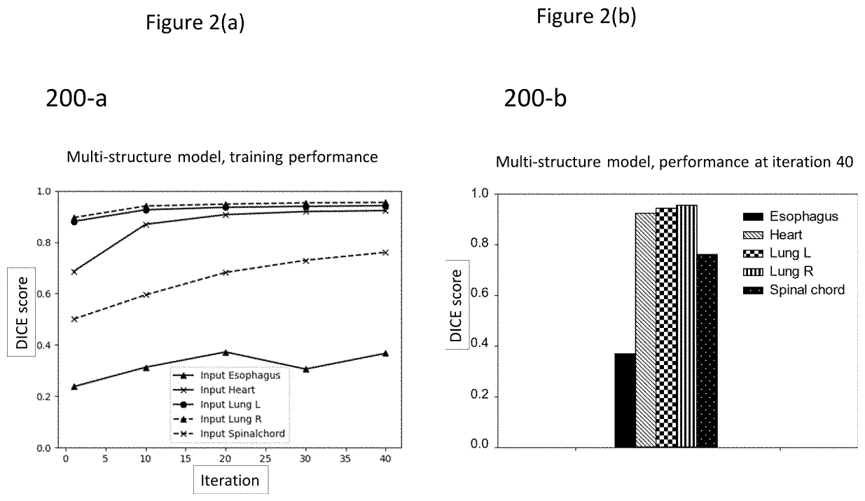

In an embodiment of the invention a deep learning segmentation model, using a convolutional neural network, such as a U-Net, was trained using two alternative approaches. The models were trained either including contours from a single organ (FIG. 1 as discussed above) or from a variety of different organs (FIG. 2 discussed below). Contextual information was provided to the model, using the prior contoured image slice as an input, in addition to the image slice to be contoured. The case of the dataset contains five OARs: heart, left and right lung, oesophagus and spinal cord. 12082 contoured organ image slices were used for slice-by-slice training. Results were evaluated on 4647 image slices using Dice similarity coefficient. Both models, were evaluated on all OARs, regardless of the training set used.

An example of results demonstrating this using the subject invention is shown in FIG. 2. It shows how the contouring performance (as measured by the Dice score) generally improves for all structures tested during training (FIG. 2a) if trained on a training set that includes various anatomical structures simultaneously. In this embodiment of the invention, FIG. 2a shows results for testing the model using the esophagus, heart, left and right lungs and the spinal cord. For a multi-organ model, the Dice score for heart segmentation was 0.92 with a mean Dice score of 0.76 for the other OARs.

This is in contrast to the alternative single-structure model that is shown in FIG. 1, where training was done using the heart, and the results for all the other organs (that were not used during the training had very low Dice scores, where the mean Dice score for the other 4 OARs was 0.025. As is clear from this figure, the single-organ model can only contour the organ it has been trained on, but fails to contour organs outside the training set despite being provided context information.

In contrast, a model trained on various different organs learns to predict different organs based on the context between the image and corresponding image contour. This invention has demonstrated that user provided context (such as a user-generated contour) can be incorporated into deep learning contouring to facilitate semi-automatic segmentation of medical imaging, for a variety of different imaging methodologies. An appropriate training set is selected to ensure that the approach generalises to use prior context rather than learning organ-specific segmentation. Such an approach may enable faster de-novo contouring in clinical practice. In this invention, the segmentation performance of a single-organ model trained on a heart training set (FIG. 1) is compared to a multi-organ model that has been trained on a set of organs: heart, left/right lung, oesophagus, spinal cord (FIG. 2).

A single-organ model that has only been trained on hearts only learns to contour exclusively that structure, despite provided context (FIG. 1b), while a multi-structure model can contour various structures successfully (FIG. 2b). It should be noted that in the training process the single-organ model performs reasonably for the first iteration of training, but then gets worse for all organs but the heart (FIG. 1a). In contrast, the multi-organ model shows improvements in all organs tested throughout training (FIG. 2a). In addition, the heart segmentation performance of the multi-organ model remains similar to the performance of the single-organ model.

Therefore, an appropriate training set must be selected to ensure that the approach generalises to use prior context rather than learning organ-specific segmentation. Such an approach may enable faster de-novo contouring in clinical practice.

The models to be discussed below will be referred to as either single-structure or multi-structure model based on the training set provided. Preferably they will be machine learning models. A single-structure model is a model trained using a single structure (for example hearts or right lungs etc.), while in multi-structure models, a diverse set of different structures are used during training (e.g hearts and lungs and spinal cord and tumours). In a preferred embodiment of the invention, the machine learning system distinguishes which structure to segment by the contextual information of the user generated contour data provided associated with the previous image slice. Labelling refers to the labels assigned to different structures in the data set. Generally, different structures can be distinguished by their associated label. Multi-structure training is based on a training set composed of different structures, but all having the same label. This allows for generalized learning of contextual information rather than structure specific features because a diverse set of structures is available for training, which to the model are indistinguishable unless the provided context information is learnt.

A single-structure model that has been trained on only one structure (FIG. 1) will only learn how to contour the structure on which it has been trained, while a multi-structure model that has been trained using a plurality of different structures will be able to contour various different structures (FIG. 2) in a medical image. Because the multi-structure model learns from context, the multi-structure model will have the ability to segment previously unseen structures that have not been included in the training set. This method could provide an invaluable tool to assist clinicians in segmenting any structures they need to contour without requiring individual models for each structure or organ of interest. This includes structures for which it is challenging to find a suitable training set (for example tumours).

We demonstrate this by providing input contours of diverse structures (for example, contours corresponding to heart, left lung, right lung, spinal cord, oesophagus) as input to the machine learning model and preferably evaluating the segmentation of the images using the Dice score as a performance metric. If the input contour is the structure that the model has been initially trained on, then the single-structure model segmentation is successful. However, if a different structure is provided as input, rather than the structure as used for training the model, the single-structure model image segmentation fails, despite the provided context (FIG. 1b). Therefore, this model is unable to contour previously unconsidered structures.

For multi-structure training (FIG. 2b), the ML model learns to segment different structures in the image based on the contextual information between input image slice and the associated input contour without any prior labelling of the structure. In such multi-structure training the machine learning model generalizes and is able to segment diverse structures based on the input contour provided by the user, as a user generated contour.

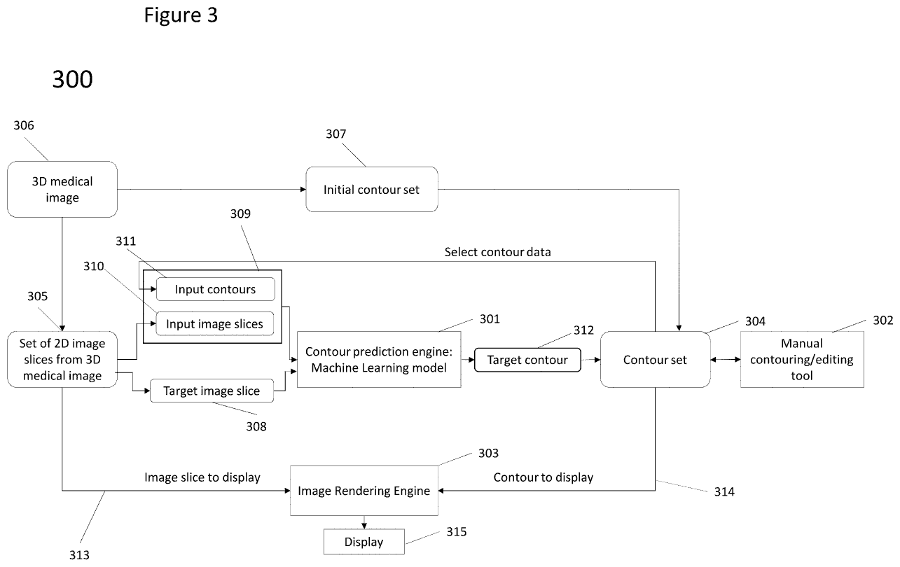

FIG. 3 shows a flow diagram of an example system for contouring a 3D medical image to delineate structures of interest in the image, comprising a set of 2D medical image slices as used in an embodiment of this invention. As shown, the system includes contour prediction engine 301. This is a system component that predicts the target contour using the target image slice, input image slice(s) and input contour(s). A manual contouring and editing tool 302 and an image rendering engine 303 are also provided. The image rendering engine is a system component that enables display of the image data and contour data, and the manual contouring and editing tool is a tool to create contours or edit existing contours within the contour set relating to the set of 2D image slices from a 3D medical image. These system components enable the user to create and edit a set of contours 304 from a set of 2D medical image slices 305. In an embodiment of the invention, the prediction engine 301, contouring and editing tool 302 and image rendering engine 303 are provided as part of a computer (not shown) or as part of a computer program package, the computer may also include a storage system for storing a database of 3D and 2D medical images, as well as a display, for display of the image, as well as external hardware components such as a mouse, or other device for manual contouring of the images if needed.

As used throughout this description, the structure of interest in an image refers to an anatomical structure the user wants to contour within the 3D medical image, the structure of interest may include organs (such as heart or lungs for example) which generally have a known well-defined structure or anatomy, or tumours, which have highly variable appearance and size/shape. Unlike most machine learning approaches, the method of this invention includes structures that have not previously been used in the machine learning training of the contour prediction engine. For example, a model that has included lung, heart, bladder, and lung tumours in its training set needs to generalize and be able to also predict the contours of the spinal cord, given the provided input contour data 311 represents the spinal cord as the structure of interest.

The set of 2D image slices 305 and the set of contours corresponding to those image slices 304, can be displayed to the user via an Image Rendering Engine 303 and any appropriate displaying device 315.

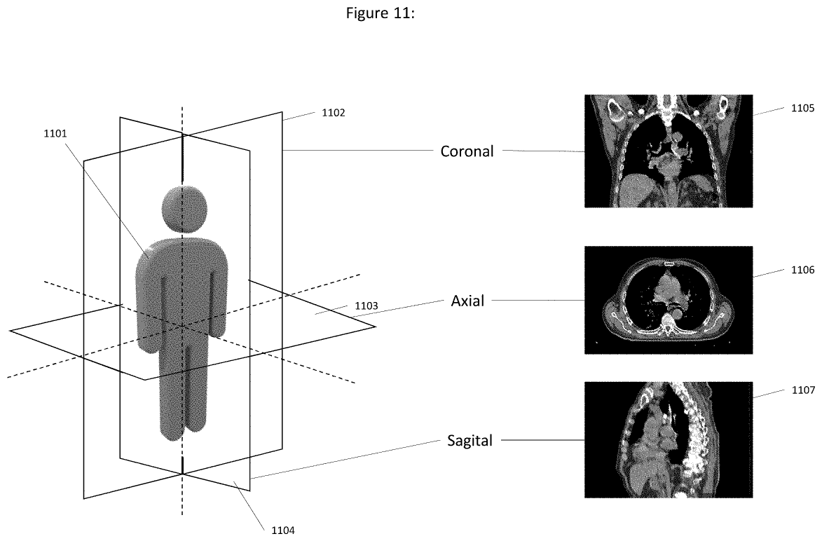

A 3D medical image 306 is used to create the set of 2D images slices 305. Typically, in an embodiment of the invention this will be image slices according to one of the 3 planes, Axial, Sagittal, Coronal or according to the image acquisition plane. FIG. 11 (as discussed later) shows these various different image acquisition planes.

When a 3D medical image 306 is initially selected/loaded, an initial image contour set 307 is either loaded from an existing set of contours associated with the 3D medical image 306, or an initial image contour set is created by the user for one or more image slices using the manual contouring tools 302. This initial contour set is the set of contours prior to any processing using the contour prediction engine.

The initial contour set 307 is then added to the contour set 304.

An input target image slice 308 to be contoured is selected from the set of 2D image slices 305. The required contextual information input 309 is selected from the contour set 304 and the set of 2D image slices 305.

The contour prediction engine 301 is provided with different inputs which allow the prediction of the contours. As shown in FIG. 3, in an embodiment of the invention there are two inputs to the contour prediction engine 301.

The first input is a target image slice 308, which is the image slice to be contoured and/or the image slice for which a contour is predicted, provided from the set of 2D image slices 305, of the 3D medical image 306.

The second input to the contour prediction engine 301 is a contextual information input 309. In an embodiment of the invention the contextual information input preferably consists of a set of at least one input image slices 310 and a set of at least one associated input contour 311.

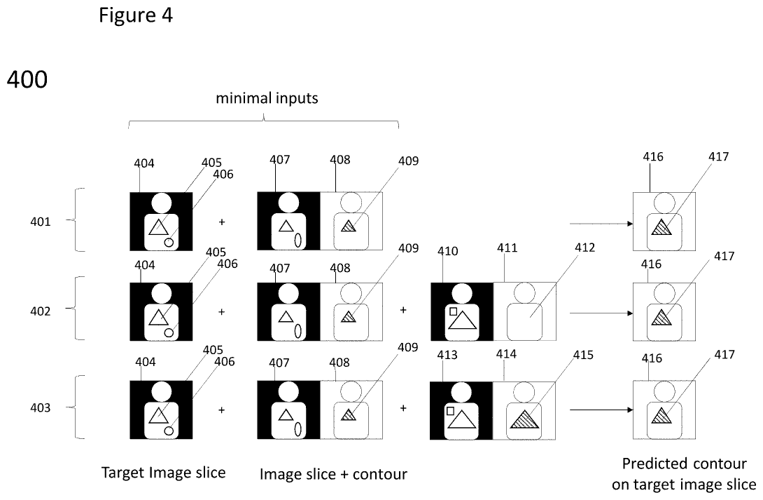

The second (contextual information) input 309 could be for example, one of the possible combinations, as illustrated in FIG. 4 which shows three examples for the different input variants 401, 402, 403 to the contour prediction engine 301. Other examples may also be possible in alternative embodiments of the invention.

The first example input has one single contour of the structure of interest+its associated 2D image slice as illustrated at 401;

The second example input has multiple contours of the structure of interest+their associated 2D image slices. In this example input, one of the contours is an empty mask 412, indicating an image slice that does not contain the structure of interest as illustrated at 402;

The third example input is 403. This shows multiple contours of the structure of interest+their associated 2D image slices.

A target image slice 404, is shown for each of the three different inputs 401, 042, 403. The target image slice 404 is the image slice to be contoured and/or the image slice for which a contour is predicted.

All the three different input variants 401, 402, 403 include the target image slice 404, that contains the structure of interest 405 and can contain one or more other structures 406. These structures, may be heart, lungs, other organs, or other structures such as a tumour for example. If the target image slice does not contain the structure of interest 405, then no contour is returned by the contour prediction engine 301.

The first input variant 401, shows the minimal input required for the contour prediction engine 301. As a minimum, the input to the contour prediction engine 301 requires target image slice 404 as contextual information input: one input image slice 407 and one input contour 408 associated to the image slice 407. The structure of interest 409 on input contour 408 identifies the structure of interest 405 to be segmented on the target slice 404.

In an embodiment of the invention, the combination of input image slice and associated input contour referring to the structure of interest is required to provide the necessary contextual information. This combination of input image slice and associated input contour relates the structure described by the input contour to the input image slice and enables the machine learning model to identify what structure to contour on the target image slice. The ML model of the contour prediction engine is thus sensitive to what the user intends to contour rather than having learnt to contour a set of specific organs. The contextual information is important in allowing the contour prediction engine to determine what is to be contoured rather than identifying structures based on image features alone.

Input variant 402, requires an input image slice 410 and associated input contour data 411 in addition to the minimum input requirements that are described above for the first input 401. In this example input, the input contour 411 is empty and does not include any reference 412 between the structure of interest 405 to the input image slice 410. This can be useful contextual information, as it indicates to the contour prediction engine what the structure of interest does not look like.

The third input variant 403, requires an input image slice 413 and associated input contour data 414 in addition to the minimum input requirements of input 401. The input contour 414 identifies the structure of interest 415 that relates to the structure of interest 405 to be segmented on the target image slice 404.

Using either of the different input variants 401, 402, 403 or any extension of them, the target contour 416 associated to the target image slice 404 can be predicted by the contour prediction engine 301. The structure of interest 417 in the target contour 416 relates to the structure of interest 405.

An extension of the different input variants 401, 402, 403 is possible in some embodiments of the invention, for example, by adding additional input image slice and input contour pairs as inputs to the contour prediction engine 301.

The at least one input image slices 310, and the at least one associated input contour data 311 to the machine learning model can be adjacent image slices to the target image slice, but they may also be separated by any number of slices from the target image slice. Thus, this invention does not have any limitation on the image slices that can be used as input and target image slices. In a preferred embodiment of the invention, contours for sequential image slices will be predicted sequentially, and the predicted contour for the nth image slice will be the input for the n+1th target image slice, to predict the contour for that subsequent target image slice.

Reverting back now to the flow diagram of FIG. 3, contour prediction engine 301 uses the different inputs 401, 402, 403 as described with reference to FIG. 4 in order to predict the target contour 312 for the target image slice 308 using a machine learning model. The predicted target contour 312 can then be added to the contour set 304, after it has been predicted.

A manual contouring or editing tool 302 allows a user to interact with the contour set 304. This may be provided within the overall system, or as a separate add-on program for performing contouring or editing. The user can either manually edit existing contours within a particular contour set 304, or the user may manually create new contours of one or more structures of interest associated to the set of 2D image slices 305. The one or more new contours created or edited with the manual contouring tool are added to the contour set 304.

Thus, as described above, and illustrated in FIG. 3, contour prediction engine 301 requires the following:

1) a target image slice 308, which is the image slice to be contoured/the image slice for which a contour is predicted; and
2) contextual information input 309 that consists of a set of at least one input image slices 310 and a set of at least one associated input contour 311.

Using these two separate inputs to the contour prediction engine 301, the machine learning model of the contour prediction engine 301 estimates the target contour 312 of the target image slice 308 of the structure that has been contoured on the input slice 310.

Different sets of inputs can be at different slice distances. For example, image slice 606 and input contour 605 can be 3 slices from the target image slice 602, while the input image slice 608 can be at 5 slices of the target image slice in either direction within the 3D image stack.

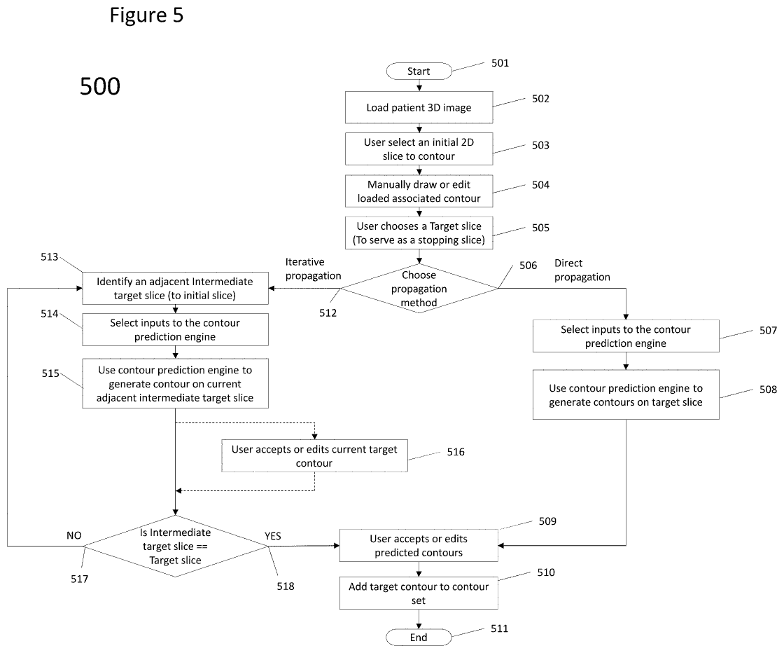

FIG. 5 is a flow diagram showing the interactive contouring application workflow for this invention. As shown, the figure details different elements of the contour propagation.

Step 501 shows the start of the workflow for the interactive contouring. This is followed by the user loading a patient 3D image at 502. After this, the user selects an initial 2D image slice that they want to contour 503. In some alternative embodiments of the invention, the use may also select multiple image slices that they want to predict contours for.

The user either manually draws a contour on the selected 2D image slice identifying the structure of interest 504, OR the user can load a contour of the structure of interest. The user can accept or edit the loaded contour.

The user chooses a target image slice (To serve as a stopping image slice) 505. The target image slice will be an image slice in the image set 305, that is n slices away from the initial image slice, where all image slices between the initial image slice and the target image slice will be contoured, hence the target image slice, will be contoured, but then the contouring will be stopped and no further image slices of the set of 2D image slices 305 will be contoured.

In an embodiment of the invention, to predict the target contour with the contour prediction engine 301, two different contour propagation methods are possible (the method that will be used is typically selected by user or pre-set in the system configuration). These two alternative methods are Direct contour propagation 506 or iterative contour propagation 512.

The steps for direct contour propagation 506 in an embodiment of the invention are as follows: User or system (according to system configuration) selects the inputs 507 to contour prediction engine 301 given any of the input variants 401, 402, 403 as previously described in FIG. 4. The input to the contour prediction engine 301 includes the (manually defined or loaded with or without manual edits) user contour(s) as already defined above in step 504 and also the target image slice previously identified in step 505.

The contour prediction engine 301 then predicts the target contour associated with the target image slice at step 508. Following on from this, the user accepts or edits the predicted contour at step 509. Following this the newly generated target contour is added to the contour set at step 510. The process then ends at step 511.

The alternative contour propagation pathway is iterative contour propagation at step 512. In this alternative pathway, the system identifies an adjacent intermediate target image slice (to initial slice) at step 513. The intermediate target image slices are all slices that are spatially between the initial user identified image slice and the target image slice. Following the identification of the intermediate image slice, the system (according to system configuration) selects inputs to the contour prediction engine at step 514.

If this step is the first iteration of the contour propagation, then the user input(s) is(are) used for the contextual information input and the intermediate target image slice as “the target image slice” For every following iteration after the first, the prior intermediated target image slice(s) and the associated predicted contour(s) for the image slice(s) are used as the contextual information that is input to the contour prediction engine 301.

At step 515 contour prediction engine generates the target contour for the current adjacent intermediate target image slice. At step 516 the user may or may not edit the current target contour. If the intermediate target image slice is not the target image slice identified by the user at step 517, then steps 513 to 516 are repeated for all necessary iterations until arriving at the target image slice that was previously identified by the user.

If the intermediate target image slice is the target image slice identified by the user 518, then the iterative contour propagation steps are completed and the user can accept or edit the predicted contour(s) at step 509. The target contour is then added to contour set 510, and the iterative contour propagation ends at step 511.

When the end is reached at step 511, the user can select a new target image slice and repeat the workflow if required to generate contours for the new target image slice, using either of the two propogation methods described above. In an embodiment of the invention, all the contours are generated using the same contour propogation method. However, in an alternative embodiment of the invention, subsequent contours may be generated using either of the contour propagation methods.

The system may have a configuration setting such that the workflow is executed until all 2D image slices have a corresponding contour in the 3D image. The workflow can be managed automatically or manually according to user preference.

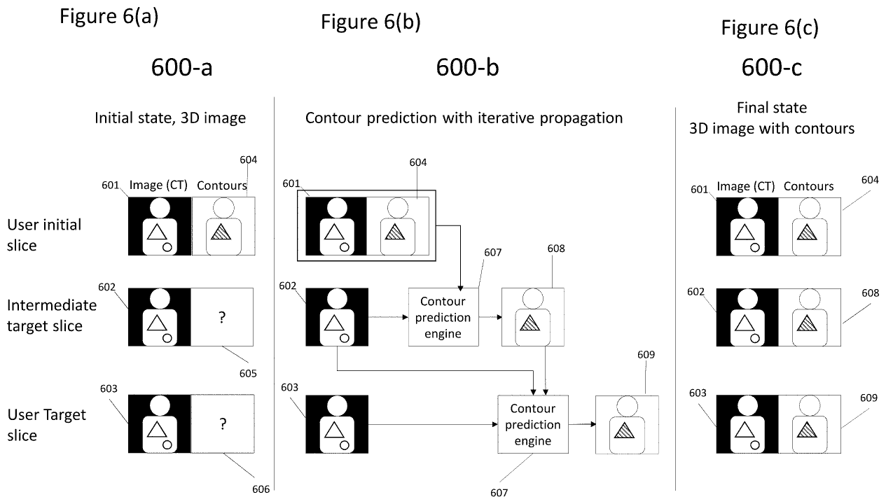

FIG. 6 illustrates the iterative propagation approach for prediction of target contours as described with reference to FIG. 5 above. The figure shows the initial state (FIG. 6(a)), the contour prediction with iterative propagation (FIG. 6(b)), and the final 3D image with contours (FIG. 6(c)).

An exemplary starting state in the contouring application is shown in FIG. 6a. The set of 2D image slices from a 3D medical image consists of 3 image slices 601, 602, 603. The user selected initial image slice 601 has an associated contour 604 describing a structure of interest. The user target image slice 603 is the image slice the user wants to contour and has no associated contour (illustrated by 606). Spatially in-between the user initial image slice 601 and the user target image slice 603 is one intermediate target image slice 602. The intermediate target image slice 602 has no associated contour (illustrated by 605).

The iterative contour propagation based on the starting state is illustrated in FIG. 6b.

First, the contour 605 for the intermediate target image slice 602 needs to be predicted. Therefore,
the intermediate target image slice 602,
and contextual information input consisting of
   the user initial image slice 601
   and associated contour data 604 are processed by the contour prediction engine 607 to predict the intermediate target contour 608.
      Second, the contour 606 for the user target slice 603 also has to be predicted. Therefore,
the user target image slice 603,
and contextual information input consisting of
   the intermediate target image slice 602
   and associated intermediate target contour data 608 are processed by the contour prediction engine 607 to predict the user target contour 609.

This iterative contour prediction process may be applied for multiple intermediate target image slices.

The final state after iterative contour propagation is shown in FIG. 6c. The image slices 601, 602, 603 and corresponding contours 604, 608, 609, respectively, can be displayed. As shown, the images are CT images, but the methodology of this method, as shown in this figure can be applied to arrange of different imaging modalities.

The intermediate target contours 608 as shown in figure (b) may be discarded or kept depending on system configuration, as they may be useful for subsequent processing or applications.

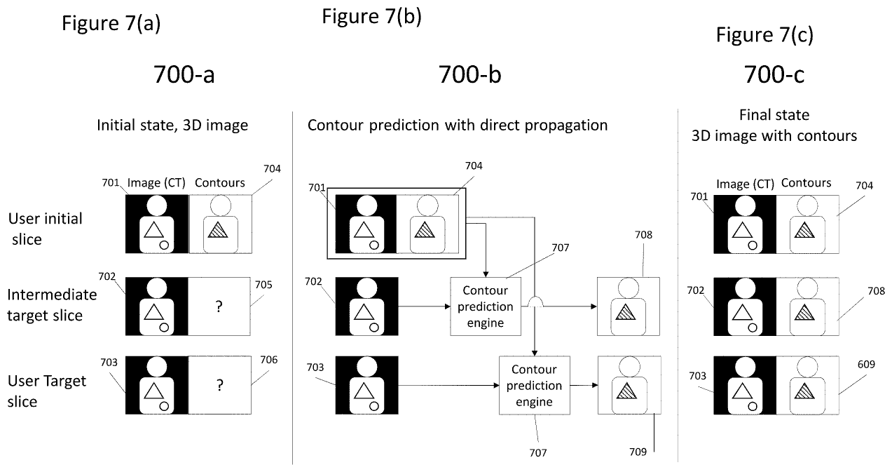

FIG. 7 illustrates the alternative direct propagation approach for the prediction of target contours corresponding to steps 506-509 of the workflow of FIG. 5. The figure shows the initial state (FIG. 7(a)), the contour prediction with the initial user image slice (FIG. 7(b)), and the final 3D image with contours (FIG. 7(c)).

An exemplary starting state in the contouring application is shown in FIG. 7a. The set of 2D image slices from a 3D medical image consists of 3 image slices 701, 702, 703. The user selected initial image slice 701 has an associated contour data 704 describing a structure of interest. The user intends to contour either the image slices 702 and 703, or only one of the two. As shown, image slice 702 and image slice 703 have no associated contours (illustrated by 705 and 706, respectively).

The direct contour propagation based on the starting state is illustrated in FIG. 7b.

If the user selects the image slice 702 as the target image slice of the contour prediction engine, the contour 705 on the target image slice 702 is the contour that has to be predicted. Therefore,
the target image slice 702,
and contextual information input consisting of
   the user initial image slice 701
   and associated contour data 704 are processed by the contour prediction engine 707 to predict the target contour 708.
      If the user selects image slice 703 as the target image slice of the contour prediction engine, the contour 706 on the target image slice 703 is to be predicted. Therefore,
the target image slice 703,
and contextual information input consisting of
   the user initial image slice 701
   and associated contour data 704 are processed by the contour prediction engine 707 to predict the target contour 709.
      The final state after propagation is shown in FIG. 7c. The image slices 701, 702, 703 and corresponding contours 704, 708, 709, respectively, can be displayed.

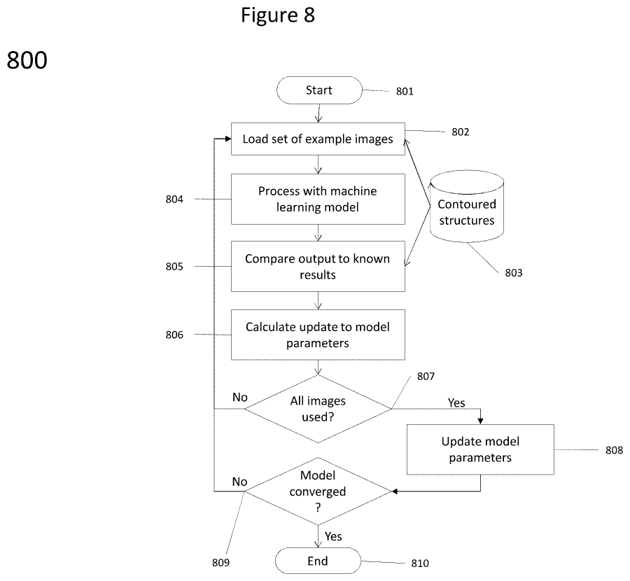

FIG. 8 illustrates the process of training machine learning model for contouring a medical image. The training process start at step 801 and progresses to step 802. At step 802 one or more example images are loaded from a database 803 of images with previous contoured structures. In the preferred embodiment of the invention the images with the associated contours from the database are then processed at step 804 with the chosen architecture of the machine learning model, with its current parameter settings (these may have been initialized randomly, or from a prior trained machine learning model on other data). The output of the current ML model is then compared at step 805 to the known “correct” contours associated with the inputs images, loaded from database 803. An update to the ML model parameters is calculated at step 806 so as to reduce the error between the predicted contours by the current ML model and the known correct contours. The process can be iterated over the whole database of images 803 in batches loaded at 802, progressing from 807 back to 802 until all training images have been considered. Once all images, or a chosen size subset of images, have been considered, the ML model parameters calculated at 806 at each iteration are combined and the ML model is updated at 808. The process from step 802 to step 808 is repeated for a set number of iterations or until it is determined that the ML model parameters have converged at 809. Once this iteration process is complete, the training terminates at step 810 with a set of ML model parameters tuned.

The disclosed method integrates a machine learning model to predict the target contours from given input image slices and associated input contours. Convolutional neural networks have shown great success in image segmentation tasks. But different machine learning models or a combination of these, such as for example random forest models or decision trees can also be adapted for the interactive contouring method of this invention. Recurrent neural networks can be particularly useful to further take advantage of contextual features when propagating the contour in the entire 3D medical image. The contour prediction engine of the disclosed invention preferably uses machine learning, and in preferred embodiments of the invention may be any combination of the below machine learning techniques:

Deep neural network including Convolutional Neural network

Random forest

Recurrent neural networks

For the disclosed method of the subject invention, it is important to construct a model that can contour a user defined structure in a 3D medical image based on contextual information, including information from those unidentified structures of interest in the medical image that have not been represented within the training set. In a preferred embodiment of the invention, one or more of the target image slice, the input of one or more image slices and the input contours, can provide contextual information to identify a relevant location for a contour on the target slice. In some embodiments of the invention, the contextual information may comprise one or more items of information on image features, or spatial relations between image data and/or contour data, that may be learnt from the training data

In some embodiments of the invention, the contextual information is information relating to one or more features shared between image slices in the set of 2D image slices, in some cases the image slices are consecutive image slices in the set of 2D images.

Generalization of the model can be achieved, for example, by an adequate choice of the training set and using the training of the model as disclosed for this invention. Instead of training on a single anatomical structure (e.g. only heart), defined by a single contour label, as is widely done for optimization in segmentation tasks in medical images, training should be performed simultaneously on multiple structures (e.g. heart and lung and spinal cord), but with a shared single contour label.

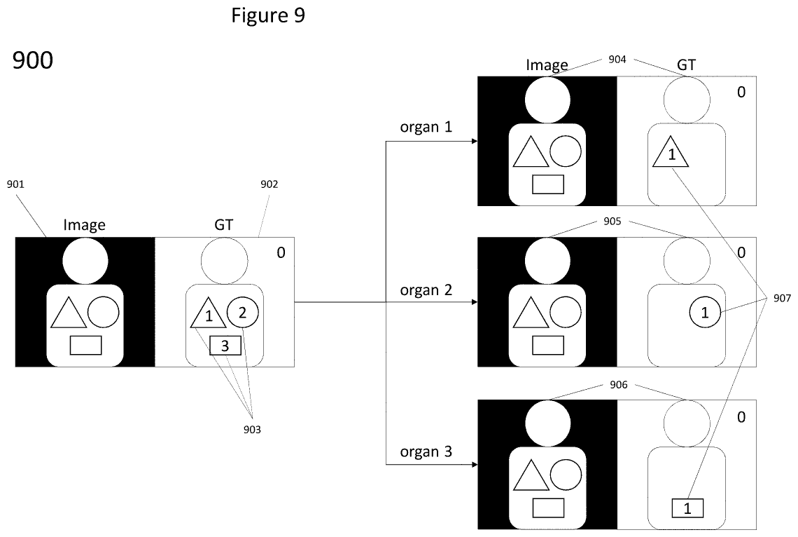

The generation of training data in the multi-structure approach is shown in FIG. 9.

The training set typically consists of multiple previously contoured images, each of which can consist of a different number of structures. An image that is associated with n different structures may be copied and used n-times. However, each time that the image is used, it will only be used with one structure at a time with an identical label.

Previous approaches have associated a different label with each structure in the image, thus training multi-label segmentation approached (i.e the model predicts more than one foreground label at once, for example a heart label and a lung label). However, when training with multiple structures to allow contextual information to be learnt, it is important that all structures are labelled the same and as such are indistinguishably labelled such that a generalizable model can be learnt. The spatial contextual information provided with the image slice to be segmented identifies what structure to contour in the image.

For all contoured images in the training set, each input image slice 901 is paired with its associated contour data 902. The contour data 902 may contain contours of multiple different structures 903. For each of the multiple different structures shown on contour data 902, a separate image-contour pair (904, 905, 906) is added to the training set. Each structure of the multiple different structures 903 will be labelled with the same label 907, in FIG. 9, these are shown with the label “1” on the pictures on the righthand side of the figure. The initial 3D image 901 remains unchanged in the process.

In the various embodiments of the invention described above, the method has been applied to CT images. However, to further increase generalizability of the model, the training set can be extended to include different medical imaging modalities, including but not limited to CT, MRI, ultrasound, CBCT. In one embodiment of the invention the training of the machine learning is done based on a single imaging modality. In other embodiments of the invention, the training of the machine learning model is performed on multiple imaging modalities.

We note that machine learning methods are broadly applied that employ multiple structures. These refer to the simultaneous learning to classify different structures or predict segmentation of different structures simultaneously where a different label is applied to each structure to identify that structure. In contrast to the disclosed invention, these methods rely on a training set with distinctly labelled structures, while in the disclosed method the label information is deliberately neglected.

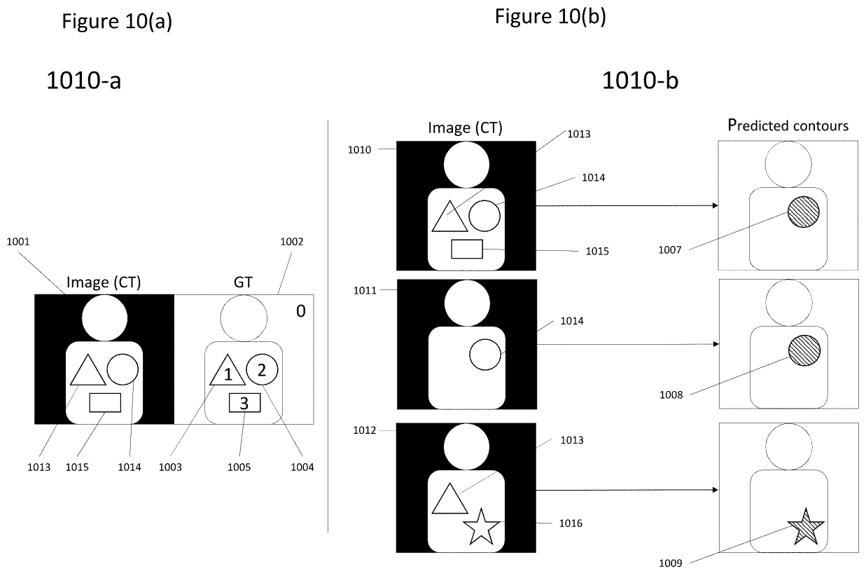

FIG. 10 show schematic examples of structures in the training set and examples of structures to be contoured with the disclosed invention. The figure illustrates the contouring of unseen structures by the ML in training.

FIG. 10a. shows a schematic example of the data set used for training the ML model. The training set consists of 3D medical images 1001 and the associated contours data 1002. All the 3D medical images in the training set are showing three distinct structures of interest:

a triangle 1013, representing for example a lung tumour

a circle 1014, representing for example a heart structure.

a rectangle 1015, representing for example the liver.

The associated contours in the training set includes contours for all three distinct structures of interest:
a triangle 1003, labelled 1, representing the lung tumour contour
a circle 1004, labelled 2, representing the heart contour.a rectangle 1005, labelled 3, representing the liver contour.

This is merely an example of an embodiment of the invention, and in other cases, other structures make be contoured on the images, and the image make include more than three contoured structures of interest.

All the structures will be labelled with label “1” as described by FIG. 9 in the training process.

FIG. 10b shows three schematic examples of medical images with structures/organs to be contoured showing an example of an unseen structure by the ML in training.

The first example shows a medical image, 1010, having all the 3 organs, lung tumour 1013, heart 1014, and liver 1015 (as described above) as the typical image data used in training the ML model (as shown in FIG. 10a). The contour prediction engine 301 previously described can be used to segment any of the three organs (1013, 1014, 1015) for example 1014, predicting the contour 1007 for the particular selected organ or structure of interest.

The second example shows a medical image, 1011, having only one of the organs used in the training of the ML model (1014). In this case the image shows the heart, but may show another single organ instead. The contour prediction engine 301 can be used to segment the structure of interest 1014, predicting the contour 1008 for the structure of interest.

The third example shows a medical image, 1012, having one of the organs used in the training of the ML model (1013), in this case representing the lung tumour, and a new organ, shown by star 1016, that was not previously indicated on the images of the training set, that also represent a structure or organ of interest to the user. The new organ 1016, representing for example a kidney (or any other new structure), is unseen by the ML model because it was not present in the training set, as detailed on FIG. 10a. The contour prediction engine trained as detailed in the disclosed invention can be used to segment the unseen structure of interest 1016, predicting the contour 1009 for this new previously unseen organ. This contour prediction works even though the structure 1016 was not in the training set.

Cross-sectional 2D images of a 3D medical image are typically displayed in the axial, sagittal and coronal plane. FIG. 11 illustrates these three orthogonal planes, coronal plane 1102, axial plane 1103, and sagittal plane 1104) with exemplary CT cross-sections images 1105, 1106, 1107. The orientations of the planes relative to the human body are shown in reference to a humanoid 3D-icon 1101.

The coronal plane 1102 divides the body into front and back and corresponds to the CT cross-section 1105. The axial plane 1103 is parallel to the ground and divides the body into top and bottom parts. It corresponds to the CT cross-section 1106. The sagittal plane 1104 divides the body into left and right and corresponds to the CT cross-section 1107.

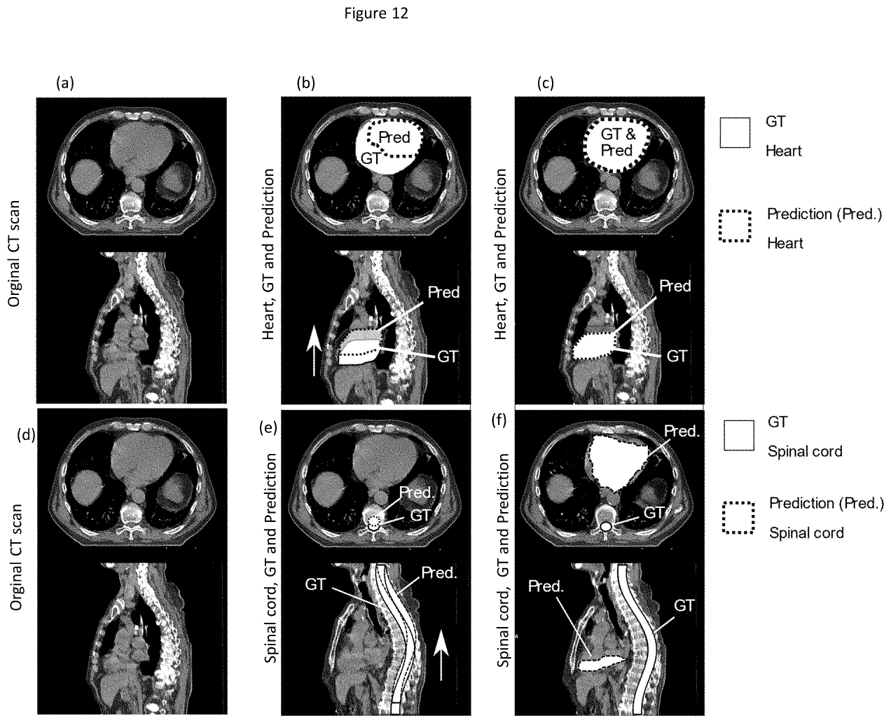

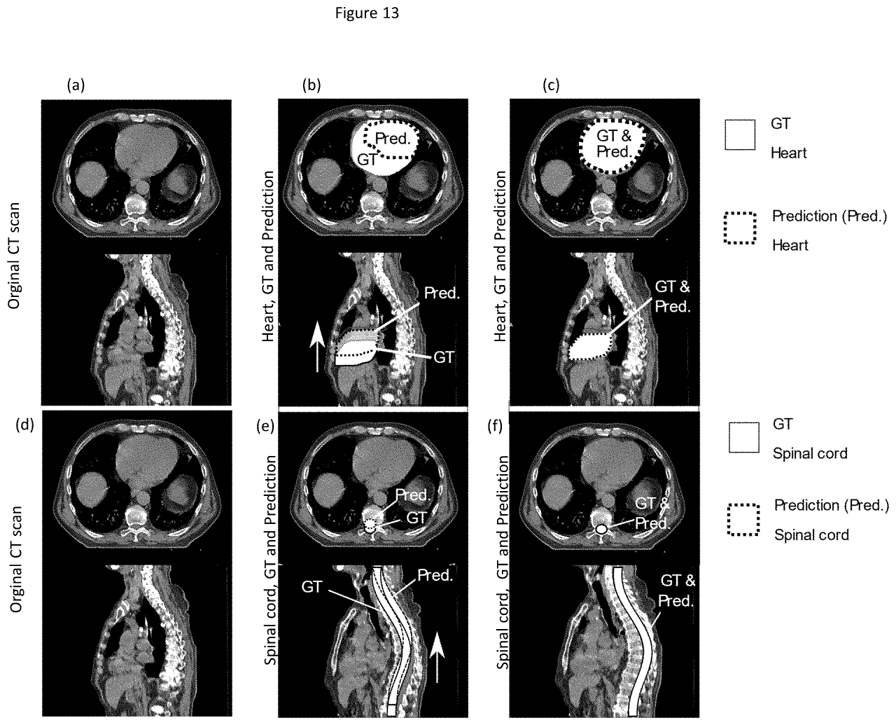

The performances of the model at different stages of training are illustrated in FIG. 12 (single-structure-training done using the heart as the single image) and FIG. 13 (multi-structure). These figures show the original scan and the contours that result after training of the model for 1 or 40 iterations. The figures show an example of an axial and sagittal planes of a 3D medical image with or without contours. The skilled person in the art would understand that FIGS. 12 and 13 are the visual outputs (illustrations) that correspond to the models as shown in FIGS. 1 and 2 respectively.

FIGS. 12 (a) and 12 (d) show the original CT scan images; FIGS. 12(b), (c) show further the GT contour for the heart and the predicted contours for a model trained for 1 and 40 iterations respectively. FIGS. 12(e) and 12(f) show also the GT contour for the spinal cord and the predicted contours after 1 and 40 iterations respectively. As shown, in FIG. 12(b), the GT contour for the heart has been correctly located. That is, the heart has been correctly contoured on the image. However, the predicted contour for the heart, after one iteration of training is not quite in alignment with the GT contour, and covers a small area of the heart relative to the GT contour as shown in the axial image, and also appears to be displaced upwards in the sagittal plane, relative to the GT contour. In FIG. 12(c), it can be seen that the predicted contour obtained with a model that was trained for 40 iterations is a good match for the GT contour in both the axial and the sagittal plane. It appears that the single organ model, trained on the heart is successful in predicting contours of the heart.

FIGS. 12(e) and (f) show the result for predicting the contour of the spinal cord, compared to the GT contour of the spinal cord, with a model trained with hearts for 1 and 40 iterations respectively. This prediction is much less successful, and by 40 iterations of the model training, the prediction is contouring the heart (FIG. 12(f)), which is the organ on which the model was originally trained on, and not the spinal cord, which is the organ that needed to be contoured and for which user input was provided as such. This clearly shows the failure of the single organ model.

FIG. 13 shows corresponding images to FIG. 12, but which have been obtained using a model trained with multiple structures, including heart, left lung, right lung, spinal cord and oesophagus. As for FIG. 12, images 13(a) and 13(d) show the original CT scan images. FIGS. 13(b), (c) show further the GT contour for the heart and the predicted contours for a model trained for 1 and 40 iterations respectively. FIGS. 13(e) and 13(f) show also the GT contour for the spinal cord and the predicted contours after 1 and 40 iterations respectively. As shown, in FIG. 13(b), the GT contour for the heart has been correctly located. That is, the heart has been correctly contoured on the image. However, the predicted contour for the heart, after one iteration is not quite in alignment with the GT contour, and covers a small area of the heart relative to the GT contour as shown in the axial image, and also appears to be displaced upwards in the sagittal plane, relative to the GT contour (as in FIG. 12 (b)). In FIG. 13(c), obtained with a model trained for 40 iterations, it can be seen that the predicted contour is a good match for the GT contour in both the axial and the sagittal plane. It appears that the multi-structure model (like the single-structure model) is successful in predicting contours of the heart.

FIGS. 13(e) and (f) show the result of the model for predicting the contour the spinal cord, compared to the GT contour of the spinal cord, with a multi-structure model trained for 1 and 40 iterations respectively. When compared to FIGS. 12(e) and (f) these predictions have been much more successful. Whilst the results after 1 iteration look very similar to the results after 1 iteration of training of the single structure model, after 40 iterations of the multi-structure model it is clear that the predicted contour aligns closely with the GT contour in both the axial and the sagittal planes.

These images clearly show that the single-structure model trained on hearts doesn't learn to contour based on the provided context and actually learns to predict hearts contours exclusively (FIG. 12(f)). In contrast, the multi-structure model accurately predicts the spinal cord at iteration 40 (FIG. 13f) and thus makes a good use of the provided contextual information.

Data augmentation approaches, as already known to those skilled in the art, can also be applied during training to assist in generalization of the machine learning model

A system and a method have been described that enable contextual information that is provided through input contours on medical images to be used for improving contouring performance and interactivity. The contour prediction engine allows efficient segmentation of structures of interest within a 3D medical image, regardless of whether examples of the structure of interest were provided in the training set, by use of a generalized machine learning model, that accounts for contextual information provided by the user.

Examples of this invention may be applied to any or all of the following: Picture archiving and communication systems (PACS); Advanced visualisation workstations; Imaging Acquisition Workstations; Web-based or cloud-based medical information and image systems; Radiotherapy Treatment planning system (TPS); Radiotherapy linear accelerator consoles; Radiotherapy proton beam console.

The present invention has been described with reference to the accompanying drawings. However, it will be appreciated that the present invention is not limited to the specific examples herein described and as illustrated in the accompanying drawings. Furthermore, because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

The invention may be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system. Therefore, some examples describe a non-transitory computer program product having executable program code stored therein for automated contouring of cone-beam CT images.

The computer program may be stored internally on a tangible and non-transitory computer readable storage medium or transmitted to the computer system via a computer readable transmission medium. All or some of the computer program may be provided on computer readable media permanently, removably or remotely coupled to an information processing system. The tangible and non-transitory computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected,’ or ‘operably coupled,’ to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

### REFERENCES

[R1] Ardon, R.; Cohen, L. D. “Fast constrained surface extraction by minimal paths”, International Journal of Computer Vision, Springer, vol. 69, pp. 127-136, 2006.
[R2] Bai, X.; Sapiro, G. “Geodesic Matting: A Framework for Fast Interactive Image and Video Segmentation and Matting”, International Journal of Computer Vision, vol. 82, no. 2, p. 113, 2009.
[R3] Boykov, Y.; Jolly, M. P. “Interactive Organ Segmentation Using Graph Cuts”, MICCAI 2000. Lecture Notes in Computer Science, vol 1935. Springer, Berlin, Heidelberg, 2000.
[R4] China, D. et al “Anatomical Structure Segmentation in Ultrasound Volumes Using Cross Frame Belief Propagating Iterative Random Walks”. IEEE J Biomed Health Inform, 2019.
[R5] Criminisi, A.; Sharp, T.; Blake, A. “GeoS: Geodesic Image Segmentation.” In Computer Vision—ECCV 2008. Springer, 2008.
[R6] Gooding, M., et al. “PV-0531: Multi-centre evaluation of atlas-based and deep learning contouring using a modified Turing Test.” Radiotherapy and Oncology, 127:S282-3, 2018.
[R7] Léger, J.; Brion, E. et al. “Contour Propagation in CT Scans with Convolutional Neural Networks”, ACIVS 2018. Lecture Notes in Computer Science, vol 11182. Springer, Cham, 2018.
[R8] Lin, D. et al. “ScribbleSup: Scribble-Supervised Convolutional Networks for Semantic Segmentation.” arXiv:1604.05144 [cs.CV] 2016.
[R9] Lustberg T, et al. “Clinical evaluation of atlas and deep learning based automatic contouring for lung cancer”, Radiotherapy and Oncology, 126(2):312-7, 2018.
[R10] Novikov, A. A.; Major, D; Wimmer, M. et al. “Deep sequential segmentation of organs in volumetric medical scans”. IEEE Trans Med Imaging 2018. doi:10.1109/TMI.2018.2881678 pmid:30452352
[R11] Oh, S. W. et al. “Fast User-Guided Video Object Segmentation by Interaction-and-Propagation Networks”. The 2018 DAVIS Challenge on Video Object Segmentation. arXiv:1904.09791 [cs.CV], 2019a.
[R12] Oh, S. W. et al. “A Unified Model for Semi-supervised and Interactive Video Object Segmentation using Space-time Memory Networks.” The 2019 DAVIS Challenge on Video Object Segmentation—CVPR Workshops, 2019b.
[R13] Olabarriaga S. D. et al “Interaction in the segmentation of medical images: A survey,” Medical Image Analysis, vol. 5, pp. 127-142, 2001.
[R14] Ramkumar, A. et al. “User Interaction in Semi-Automatic Segmentation of Organs at Risk: a Case Study in Radiotherapy.” Journal of Digital Imaging, vol. 29, pp. 264-277, 2016.
[R15] Ronneberger, O. et al. “U-Net: Convolutional Networks for Biomedical Image Segmentation”.— MICCAI 2015.
[R16] Sakinis, T. et al. “Interactive segmentation of medical images through fully convolutional neural networks”. arXiv:1903.08205 [cs.CV] 2019.
[R17] Schipaanboord B et al. “Can atlas-based auto-segmentation ever be perfect?” Insights from Extreme Value Theory. IEEE transactions on medical imaging. 2018.
[R18] Sharp G, et al. “Vision 20/20: perspectives on automated image segmentation for radiotherapy.” Medical physics, 41, 5, 2014.
[R19] Wang, G. et al. “DeeplGeoS: A Deep Interactive Geodesic Framework for Medical Image Segmentation”. arXiv:1707.00652 [cs.CV], 2017.
[R20] Wang, G. et al., “Interactive Medical Image Segmentation Using Deep Learning With Image-Specific Fine Tuning,” in IEEE Transactions on Medical Imaging, vol. 37, no. 7, pp. 1562-1573, July 2018. doi: 10.1109/TMI.2018.2791721
[R21] Zheng, Q. et al. “3D Consistent & Robust Segmentation of Cardiac Images by Deep Learning with Spatial Propagation”. IEEE Transactions on Medical Imaging, Institute of Electrical and Electronics Engineers, 2018.

1-35. (canceled)

36. A method of contouring a three-dimensional (3D) image, comprising:
receiving at least one input 2D image slice, from a set of two-dimensional (2D) image slices constituting the 3D image, and at least one set of data representing an input contour identifying one or more structures of interest in the 3D image within the at least one input 2D image slice;
receiving at least one selected target image slice, from the set of the 2D image slices; and
predicting target contour data for the selected target image slice that identifies at least one of the same one or more structures of interest within the target image slice, based on one or more of the received input 2D image slices and the data representing an input contours.

37. A method according to claim 36, wherein the target contour prediction is done using a machine learning model.

38. A method according to claim 37, where the machine learning model is one or more of a neural network or random forest.

39. A method according to claim 36, wherein the input contour identifying one of more structures of interest is identifying a previously unidentified structure of interest.

40. A method according to claim 36, wherein at least one of: the target image slice, the input image slice, and the input contour, provides contextual information to identify a relevant location for a contour on the target image slice.

41. A method according to claim 40, wherein the contextual information is provided from a plurality of sources comprised of at least one input image slices, at least one input contour, and a target image.

42. A method according to claim 40, wherein the contextual information comprises one or more of information on image features and/or contour features, or spatial relations between image data and/or contour data.

43. A method according to claim 42, wherein the contextual information on spatial relations between image data and/or contour data is learnt from a training data set.

44. A method according to claim 40, wherein the contextual information is information relating to one or more features shared between image slices in the set of 2D image slices.

45. A method according the claim 44 wherein the image slices in the set of 2D image slices are consecutive image slices.

46. A method according to claim 36, wherein the image is a medical image and the modality of the 3D image is one of: CT, MRI, Ultrasound, CBCT.

47. A method according to claim 37, where the machine learning model for predicting target contour data has been trained using an image dataset that includes a plurality of images each with one or more structures of interest shown on the images in the image dataset.

48. A method according to claim 37, where the training of the machine learning model is performed on a plurality of different imaging modalities.

49. A method according to claim 37, further comprising the step of updating the machine learning model based on user edits to the structures on one or more target image slices.

50. A method according to claim 36, where contours for adjacent slices from the set of two-dimensional (2D) image slices are sequentially predicted.

51. A method according to claim 36, wherein a first structure of interest is selected for a first 2D image slice and contours for the first structure are predicted for a first 2D image slice, and the predicted contours for the first 2D image slice are used for contouring the same structure of interest for one or more subsequent 2D image slices from the set of 2D image slices.

52. A method according to claim 51, wherein the predicted contours are propagated through sequential image slices using direct propagation of the predicted contours.

53. A method according to claim 51, wherein the predicted contours are propagated through sequential image slices by iterative propagation, with predicted contours for each subsequent image propagated based on iteration of the contours for the immediately preceding image slice.

54. A method according to claim 36, wherein the data representing an input contour is either a user-generated contour, or obtained by one or more of manual contouring, auto-contouring, or user-interactive contouring.
